(19) United States
(12) Patent Application Publication
(10) Pub. No.: US 2008/0206435 A1
(43) Pub. Date: Aug. 28, 2008

(54) Edible Oil Composition Suitable For Frying Food

(76) Inventors: Peter van den Enden, Vlaardingen (NL); Eckhard Floter, Vlaardingen (NL); Wim Theodorus Hogervorst, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/792,761

(22) PCT Filed: Nov. 18, 2005
(86) PCT No.: PCT/EP05/12499

§ 371 Date: Jun. 8, 2007

(30) Foreign Application Priority Data
Dec. 8, 2004 (EP) 04078325.0

(51) Int. Cl. A23D 9/00; A23L 1/01

(52) U.S. Cl. 426/606; 426/438

(57) ABSTRACT

Edible oil composition comprising 33 wt. % or more shea olein and one or more oils chosen from the group of rapeseed oil, soybean oil, sunflower oil or any fraction of these oils or palm olein.

### FIELD OF THE INVENTION

The present invention relates to an edible oil composition suitable for frying food.

### BACKGROUND OF THE INVENTION

Frying of food in fat or oil is a very popular method of food preparation. Deep-frying of food is used in fast food chains and restaurants, and a major portion of the fats and oils produced annually are used in frying.

Stability of the oils and fats used in frying is important.

Oxidation of frying oils may lead to undesirable off-flavours and odours as well as loss in nutritional value by the destruction of vitamins and essential fatty acids.

In deep-frying in an oil or fat, a vapor is usually formed from a material being fried and, as a result, foams are formed. While the frying is repeated, the oil or fat is deteriorated and the foaming thereof is accelerated by an influence of ingredients eluted from the materials in the course of the deep-frying. When the foaming is serious, the materials are hidden by the foams and they cannot be seen, and the foams overflow from the pan to make the cooking operation dangerous. Accordingly, the amount of the material that can be deep-fried in the oil is limited. Particularly when the material to be deep-fried contains eggs or meats, the oil or fat is rapidly deteriorated. For controlling the foaming of the oil in the course of the deep-frying, a silicone oil may be added to the oil.

Typically, the stability of frying oils can be improved by applying partial hydrogenation (also called hardening) of the oil. The hardening process of oils may lead to formation of a certain amount of so-called trans-unsaturated fatty acids (and/or triglycerides containing such trans-unsaturated fatty acids), in short TFA's. For various reasons it may be desired to reduce or eliminate the amount of trans-unsaturated fatty acids (and triglycerides thereof) in products. Fully hydrogenated oils are obviously the most stable products for frying purposes, but they have adverse effects on fat deposition on the fried food. Further there is a handling problem when the fryer has to be emptied at ambient temperatures, since at those temperatures the product is solid.

U.S. Pat. No. 6,227,433 describes randomised shea olein and the use thereof of as frying oil, see column 9. The randomised shea olein shows good frying behaviour and the decomposition of the components in the oil is reduced. The disclosed composition is solid at ambient temperatures, since claim 1 requires that the solid fat content at 20° C. is at least 8%.

An object of the invention is to provide an edible oil composition suitable for frying food. Further object is that that the composition is stable during use in frying food and or shows good foaming behaviour. It is another object of the invention to provide such compositions that show reduced polymerisation during frying. It is a further object of the invention to provide edible oil compositions are healthy, in particular those that have a low or even zero level of trans fatty acids. Another object is to provide an oil composition with improved handling characteristics.

One or more of these objects, preferably all, are attained by an edible oil composition comprising 33 wt. % or more shea olein and 1-20 ppm anti-foaming agent. We have found that these oil compositions are very suitable for frying food products and have high stability, good foaming behaviour, reduced polymerisation, and may be made with zero trans fatty acid level. The edible oil composition preferably comprises 50 wt. % or more shea olein. The oil compositions according to the invention have as additional advantage that they are solid at refrigeration temperatures (e.g. 5°) and fluid at room temperature (20° C.). Depending on the preferred use in the kitchen, the chef may use the oil composition as solid, e.g. in blocks (from the refrigerator) or as pourable material (when kept at room temperature or above).

### SUMMARY OF THE INVENTION

According to a first aspect of the invention, there is provided an edible oil composition comprising 33 wt. % or more shea olein and one or more oils chosen from the group of rapeseed oil, soybean oil, sunflower oil or any fraction of these oils or palm olein.

In a second aspect, the invention relates to the use of an edible oil composition comprising 33 wt. % or more shea olein as a frying oil.

### DETAILED DESCRIPTION OF THE INVENTION

Shea olein is a secondary fraction from the sheanut oil fractionation (shea stearin is the primary fraction being a cocoabutter equivalent). The fatty acids in sheanut oil consists of about 40 wt. % of stearic acid and 45 wt. % of oleic acid. Shea olein, obtained after fractionation contains more than 65 wt. % of oleic acid fatty acids.

An additional advantage of shea olein is that Shea olein may be derived from sheanut oil, a natural product using only a natural process steps, being fractionation. If only shea olein or a mixture of shea olein and other natural oils is used, a fully natural edible oil composition, beneficial for the human health, may be obtained. Measures such as (chemical) hydrogenation, resulting in increased levels of trans fatty acids, interesterification and the use of oils from genetically modified seeds may be avoided. The edible oil composition preferably comprises 50 wt. % or more shea olein, or even 75 wt. % or more. The oil composition further comprises one or more oils chosen from the group of rapeseed oil, soybean oil, sunflower oil or any fraction of these oils or palm olein. A preferred embodiment of the invention is a blend of shea olein and rapeseed oil, in particular a blend of about 50-60 wt. % shea olein and about 40-50 wt. % rapeseed oil. The upper limit of the amount of shea oil may be as high as 90 wt. %, 98 wt. % or even 100 wt %.

The edible oil composition according to the present invention may comprise in addition to the shea olein and other vegetable oils, minor ingredients conventionally found in frying oils including antifoaming agents, such as silicon oils, anti-spattering agents, anti-oxidants, such as naturally present or added tocopherols, citric acid, ascorbic acid, butylated hydroxytoluene, -anisole or -quinons, flavouring agents, and the like. The present edible oil composition may also contain emulsifiers such as mono- and diglycerides and lecithin. Preferably, added emulsifier constitute less than 3 wt. % of the product. More preferably, the present edible oil composition contains less than 2 wt. % of added emulsifier.

Another aspect of the present invention is the use of an edible oil composition, as described hereinbefore, for frying food. When using the edible oil composition according to the invention for frying food products., suitably, frying temperatures in the range of 120-200° C. are employed. The edible oil composition according to the invention can advantageously be used for both shallow and deep frying food products.

The invention further relates to a process for frying food using the edible oil composition comprising 33 wt. % or more shea olein as a frying oil, preferably for deep frying or shallow frying of food, more preferably for deep frying of food. Preferably, the edible oil composition comprises 50 wt. % or more shea olein.

A further embodiment of the present invention are fried food products characterized in that they have been fried in an edible oil according to the invention.

Food products which can suitably be fried in the present edible oil composition are: potato crisps, potato and corn chips, fried snacks, fried chicken, meat and fish products, battered & crumbed fish and meat products, such as e.g. fish sticks and the like. At the point of sale these food products may either be fully baked, or be in a frozen pre-fried condition requiring further preparation by oven or microwave.

The invention will now be further illustrated by way of the following examples.

### EXAMPLES

Standard Frying Test (SFT)

The Standard Frying Test or Rost test is used herein as standard laboratory test for evaluating deep frying oils.

During this test the oil is heated to 180° C. and a number of wetted stoppers are put in the hot oil, simulating water evaporating from products that are being fried.

The test involves the following steps:
400 grams of oil is heated in a standard stainless steel container on a hot plate at 180° C. on 3 consecutive days (100 minutes in the morning and 100 minutes in the afternoon with a cooling period in between and cooling overnight).
During each heating period, 2 (regarded as 1 batch) wetted cellulose stoppers (each moistened with 1.5 ml of water) are fried every 20 minutes. This results in a total of 30 batches or 60 stoppers over the three days.
Samples of oil are taken after 10, 20 and 30 batches. These are identified as R10, R20 respectively R30.

OSI-values

Stability against oxidation (OSI values) was determined by the Rancimat method. The apparatus used was a Rancimat 617 ex Metrohm AG with accessories. Oxidation is determined by passing a stream of air through a sample of the fat, kept at 100° C.

Anisidine Value (PAV-values)

The anisidine value is a measure for the amount of unsaturated aldehydes in an oil or fat. This is determined by measuring absorbance with a spectrophotometer at 350 nm, of the sample product and a blank.

PolyTAG Data

PolyTAG data herein were determined by gel permeation chromatography. Gel permeation chromatography (GPC) is used to separate and quantify tri-, di-, mono- and polytriacyl-glycerides, fatty acid methyl esters and free fatty acids in several products and determine the amount of the polymers.

### Example 1

A blend of 55 wt. % shea olein (ex. Loders Croklaan, Netherlands) and 45 wt. % rapeseed oil was made by blending in a mixer. The resulting blend was used in the standard frying test as described herein. Results are shown in tables 1 and 2.

Example 2 and the comparative experiments were conducted according to the same process.

TABLE 1
Composition and OSI data for examples 1
and 2, comparative experiments A and B

| | | OSI |
|---|---|---|
| Examples | Product | (hrs) |
| Example 1 | 55% SHf/45% RP | 23.9 |
| Example 2 | 100% SHf | 38.7 |
| Comparative | 100% RP | 15.8 |
| Experiment A | | |
| Comparative | 22% dfPOf having IV | 16.1 |
| Experiment B | of 64/40% BO/38% RP | |

TABLE 2
Solid fat content data (as measured according to
the method above) for the products of table 1.

| | Solid fat | | | | | |
|---|---|---|---|---|---|---|
| Example | content | N5 | N10 | N15 | N20 | N25 |
| Example 1 | 55% SHf/45% RP | 22.5 | 10.5 | 0.4 | | |
| Example 2 | 100% SHf | 51.7 | 39.3 | 16.7 | 0.5 | |
| Comp. Ex A | 100% RP | 0 | 0 | 0 | 0 | 0 |
| Comp. Ex. B | 22dfPOf64IV/40 | 1 | 0.2 | 0.1 | | |
| | BO/38RP | | | | | |

In tables 1-3, %-ages are weight percentages on total product weight and the following abbreviations are used:
R0, R10, R20 and R30 are the number of frying cycles in the standard frying test.
PAV is p-anisidine value, measured in accordance with a method described above;
PolyTAG is the amount of polymer (polytriglycerides) formed, measured in accordance with a method described herein;
POf is the olein fraction of palm oil, dfPOf is a dry fractionated POf.
OV is olive oil;
OSI (hrs) is rancimat oxidation test, as measured in accordance with a method described above;
SHf=shea oleine (f=fluid fraction of shea olein) N-solids values are measured essentially as defined in Fette, Seifen, Anstrichmittel 80 180-186 (1978) at different temperatures and are expressed as N with temperature as suffix, e.g. N₂₀ is solid fat content (%) at 20° C.
IV is iodine value.

TABLE 3
Example 1, comparative experiments C-E, results
of standard frying test: PAV and PolyTAG data

| | PAV | | | PolyTAG | | | |
|---|---|---|---|---|---|---|---|
| | R10 | R20 | R30 | R0 | R10 | R20 | R30 |
| Example 1; | 25 | 40 | 68 | 3 | 3.8 | 7 | 21 |
| 100% SHf | | | | | | | |
| Comparative | 108 | 150 | 175 | 0.7 | 7.4 | 15.6 | 24.5 |
| Experiment | | | | | | | |
| C; | | | | | | | |
| POf | | | | | | | |
| Comparative | 63 | 115 | 158 | 0.8 | 5.3 | 15 | 28.8 |
| Experiment | | | | | | | |
| D; | | | | | | | |
| Refined OV | | | | | | | |
| Comparative | 211 | 324 | 401 | 0.5 | 9.7 | 20.9 | 33 |
| Experiment | | | | | | | |
| E; | | | | | | | |
| Refined SF | | | | | | | |

The results in tables 1-3 show that the product according to the invention have improved OSI-stability compared to the other oils in the test. Also the rate of polymerisation is reduced and the final anisidin values is significantly lower. This clearly indicates the superior chemical stability of the oils of the invention when used in frying.

1. Edible oil composition comprising 33 wt. % or more shea olein and one or more oils chosen from the group of rapeseed oil, soybean oil, sunflower oil or any fraction of these oils or palm olein.

2. Edible oil composition according to claim 1, comprising 50 wt. % or more shea olein.

3. Edible oil composition according to claim 1, comprising 75 wt. % or more shea olein.

4. Edible oil composition according to claim 1, wherein the composition comprises 2-50 ppm polydimethylsiloxane.

5. Use of an edible oil composition comprising 33 wt. % or more shea olein as a frying oil.

6. Use according to claim 5, wherein the frying oil is used for deep frying or shallow frying of food.

7. Use according to claim 6, for deep frying of food.

8. Use of a composition as in claim 1-4 as a frying oil.
